(19) United States
(12) Patent Application Publication
(10) Pub. No.: US 2011/0018219 A1
(43) Pub. Date: Jan. 27, 2011

(54) HYDRAULIC, RIGID REAR AXLE SUSPENSION SYSTEM FOR VEHICLES

(75) Inventors: Leo P. Oriet, Rochester Hills, MI (US); Jules Cazabon, Staples (CA)

Correspondence Address: NAVISTAR CANADA, INC.;C/O Navistar, Inc., 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 12/509,914

(22) Filed: Jul. 27, 2009

(51) Int. Cl. B60G 9/02

(52) U.S. Cl. 280/124.112

(57) ABSTRACT

A hydraulic suspension system for a tractor includes a first rock shaft generally parallel to a second rock shaft, a frame rail attached to the first rock shaft and the second rock shaft, a first trailing arm attached to the first rock shaft and having fixed rotation with the first rock shaft, and a second trailing arm attached to the second rock shaft and having fixed rotation with the second rock shaft. The suspension system also includes a first rear axle attached to the first trailing arm, and a second rear axle attached to the second trailing arm. A hydraulic cylinder is connected to the first rock shaft and to the second rock shaft.

### BACKGROUND

Embodiments described herein generally relate to suspension systems for vehicles. More specifically, embodiments described herein relate to a hydraulic rear wheel suspension system for vehicles.

Vehicle suspension systems isolate vehicles and their loads from jarring movements or shocks resulting from driving over rough terrain. The shock or energy converting elements of suspension systems may be springs. Springs are commonly associated with each wheel of the vehicle to cushion a vehicle body. An upward shock applied to the wheel may be temporarily absorbed by the compression of the adjacent spring. The shock may then be transmitted by the spring to the vehicle body as an upward force, resulting in a relatively gentle upward movement of the vehicle. The vehicle body may then settle back on the spring, which compresses the spring and returns energy to the spring.

One type of spring commonly used for large vehicles, such as tractors of trucks, is an air spring. Air springs use a contained compressible gas as the springing medium, and spring rates relate to the pressure and the volume within the air spring. When the air spring absorbs a shock, a portion of the air may be wasted to the ambient. An air compressor, such as a low efficiency piston driven air compressor, may be run by an engine of the vehicle to replenish the air that is wasted to the ambient. If the engine is used to replenish the air in the air spring, the air spring may become a parasitic device to the engine, reducing the available engine power for other vehicle components.

Reducing parasitic demands on the engine is an area of focus for electric and hybrid vehicle technology. With respect to lowering the parasitic demands of an air spring suspension system, the focus has been on lessening the parasitic loading on the engine using alternative types of air compressors.

Air spring suspension systems for trucks typically have a fixed articulation limit of about 5-6 inches between rear axles and frame rails. While 5-6 inches of articulation may be adequate for many truck uses, such as paved surface driving, 5-6 inches of articulation may not be adequate on unpaved surfaces. For example, 5-6 inches of articulation may not be adequate for trucks in use in the mining and logging industries. There are three common ranges of rear suspension articulation vocations; highway driving typically uses 5-6 inches of articulation, off-highway driving typically uses 6-10 inches of articulation, and off-road driving typically uses 10-20 inches of articulation. Separate rear suspension systems are typically used for each of these three vocations, and each separate rear suspension system typically has a fixed and non-adjustable height.

Additionally, conventional dual rear axle suspension systems may not maintain the tires parallel to the roadway when negotiating over a dip or a bump. When either end of the rear axles articulates over a bump, the opposite end of the axle rotates, which provokes lateral rear suspension shear forces, called “scrub”, and tire wear. Maintaining parallel heights between the left and the right side of the rigid rear axle, called “parallelogram rear truck suspension articulation”, may not be available with conventional dual rear axle suspension systems.

### SUMMARY

A hydraulic suspension system for a tractor includes a first rock shaft generally parallel to a second rock shaft, a frame rail attached to the first rock shaft and the second rock shaft, a first trailing arm attached to the first rock shaft and having fixed rotation with the first rock shaft, and a second trailing arm attached to the second rock shaft and having fixed rotation with the second rock shaft. The suspension system also includes a first rear axle attached to the first trailing arm, and a second rear axle attached to the second trailing arm. A hydraulic cylinder is connected to the first rock shaft and to the second rock shaft.

### BRIEF DESCRIPTION OF THE DRAWINGS

FIG. 1 is a schematic of a hydraulic suspension system.

FIG. 2 is an exploded side view of the hydraulic suspension system.

FIG. 3 is a side view of a frame rail and a cradle attaching the frame rail to the hydraulic suspension system.

FIG. 4 is a detail end view of the frame rail attached to the hydraulic suspension system with the cradle.

FIG. 5 is an exploded view of a rock shaft assembly of the hydraulic suspension system.

FIG. 6 is a section view of a hydraulic cylinder of the hydraulic suspension system.

FIG. 7 is a top view of the hydraulic suspension system.

FIG. 8 is a control schematic for automatically controlling the hydraulic suspension system.

### DETAILED DESCRIPTION

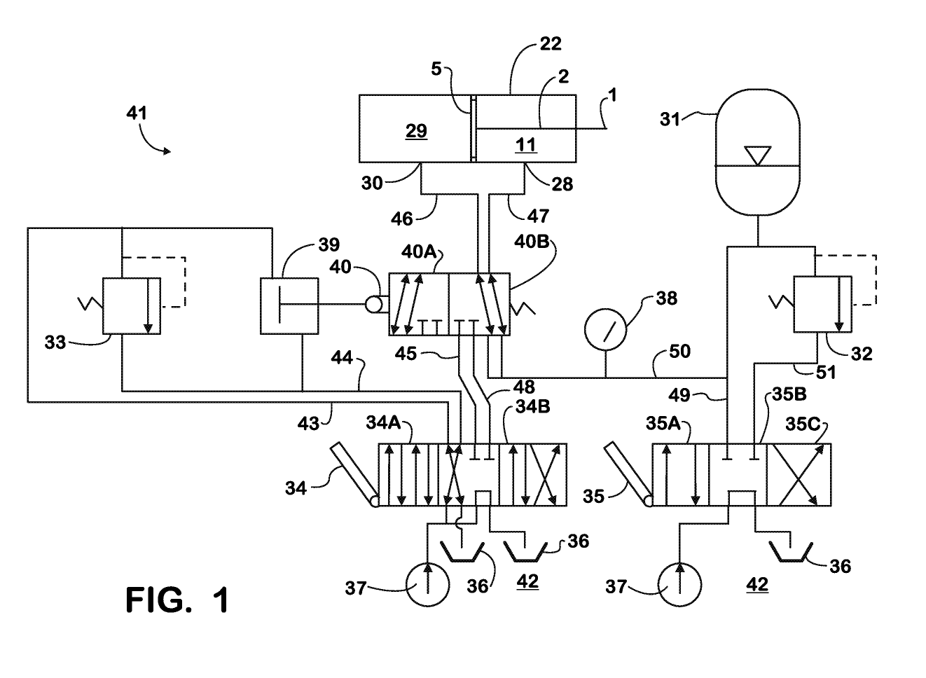

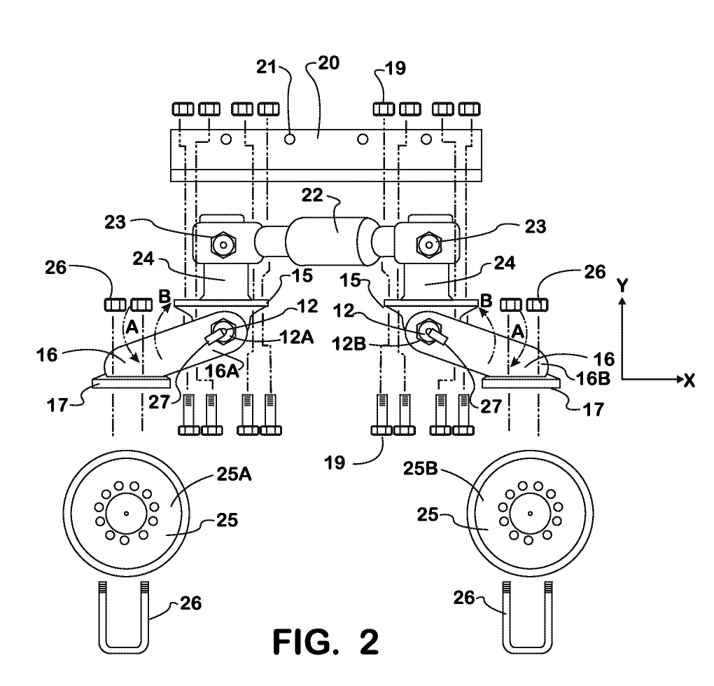

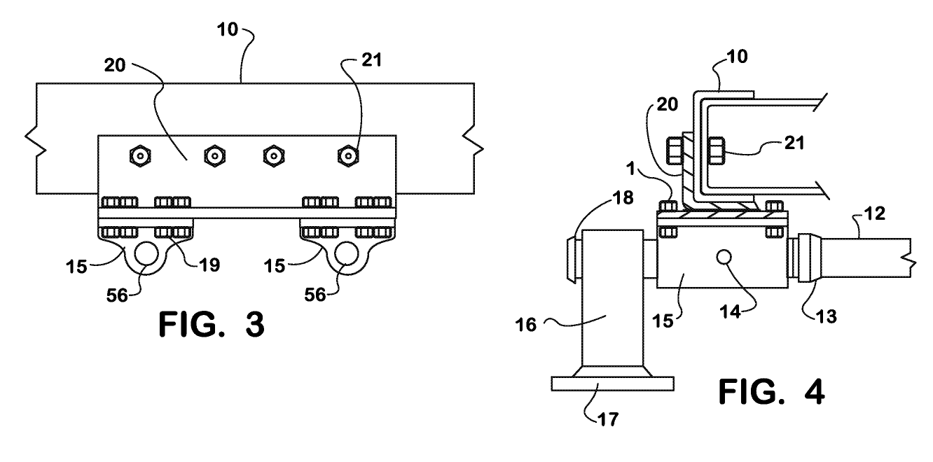

Referring now to FIG. 1, a hydraulic rigid rear axle suspension system of a vehicle, herein referred to as hydraulic suspension system, is shown generally at 41. The hydraulic suspension system 41 is a closed system that controls a hydraulic cylinder 22, which raises and lowers frame rails 10 (FIG. 3) of a tractor for a truck (not shown) relative to rigid rear axles 25 (FIG. 2).

The hydraulic cylinder 22 may have a high force cavity 29 on the thrust side of a piston 5, and a low force cavity 11 on a draw side of the piston 5. The hydraulic cylinder 22 is fluidly connected to a mode selection valve 40, which may have two positions. A first position 40A, or articulation adjustment position, allows adjustment of a maximum articulation value of the frame rails 10 (FIG. 3) relative to the rigid rear axles 25 (FIG. 2). A second position 40B, or cushion-ride pressure position, provides the hydraulic cylinder 22 with pressure in both the high force cavity 29 and the low force cavity 11 to adjust the stiffness of the hydraulic suspension system 41. The greater the amount of pressure in the hydraulic cylinder 22, the more stiff the dampening of the hydraulic suspension system 41. The lower the pressure in the hydraulic cylinder 22, the less stiff the dampening of the hydraulic suspension system 41. Depending on the position, the mode selection valve 40 allows both the maximum articulation value of the suspension system 41 to be adjusted (when valve 40 is in the first position 40A), and the stiffness of the suspension system to be adjusted (when the valve 40 is in the second position 40B).

The mode selection valve 40 permits a flow of fluid 42, such as oil or other generally non-compressible liquids, to a low force port 28 and to a high force port 30 in the hydraulic cylinder 22 to create pressure in the hydraulic cylinder. In the first position 40A, the mode selection valve 40 permits the selective fluid communication between an articulation control valve 34 and the hydraulic cylinder 22. In the first position 40A, a cushion-ride control valve 35 and a pressure absorber 31 are selectively not in fluid communication with the hydraulic cylinder 22.

The articulation control valve 34 permits the flow of fluid 42 to and from a reservoir 36, such as a non-pressurized hydraulic reservoir of oil, which may be pumped with a pump 37. In a first position 34A, or cylinder extend position, a clevis end 1 of a shaft 2 of the hydraulic cylinder 22 extends, which as will be discussed in detail below, moves the frame rail 10 upward and increases the distance between the frame rail 10 and the rear axle 25, increasing the maximum articulation value of the hydraulic suspension system 41 and the ride height of the tractor. The change in the ride height of the vehicle is the change in the distance between the rear axle 25 and the frame rail 10. As will be discussed below, the maximum articulation value is twice the ride height since the hydraulic suspension system is used with two rear axles 25 that displace in opposite directions relative to one another. It is possible that the articulation control valve 34 may be either manually controlled or automatically controlled with pneumatic, hydraulic or electrical controls, or any other controls.

The mode selection valve 40 is hydraulically actuated by a double acting hydraulic cylinder 39 that is extendable and retractable to switch between the articulation control position 40A and the cushion-ride pressure position 40B. When the valve 34 is in the cylinder extend position 34A, pump 37 draws fluid 42 from the reservoir 36, to the articulation control valve 34, to line 43, and to a double acting cylinder 39, which extends under pressure from fluid 42. The extension of the double acting cylinder 39 switches the mode selection valve 40 to the articulation adjustment position 40A. The fluid 42 from the double acting cylinder 39 and fluid from an articulation relief valve 33 flows back to the reservoir 36 on line 44 via the articulation control valve 34 (the articulation control valve is in cylinder extend position 34A).

With the articulation control valve 34 in position 34A and the mode selection valve 40 in position 40A, fluid 42 from pump 37 flows on line 45 to the mode selection valve 40, and from the mode selection valve to the high force cavity 29 on line 46. The fluid 42 flows from line 46 into the high force port 30, extending the piston 5, and drawing out fluid from the low force cavity 11 via low force port 28. From low force port 28, the fluid flows on line 47 to mode selection valve 40, from mode selection valve 40 to articulation control valve 34 on line 48, and from the articulation control valve 34 to the reservoir 36.

The articulation relief valve 33 protects the articulation control valve 34 and the double acting cylinder 39 from overload pressures that could result from excess oil flow from the pump 37 to the cylinder 22. The articulation relief valve 33 allows the fluid 42 to return to the reservoir 36 on line 44.

When the articulation control valve 34 is switched to a second position 34B, the articulation control valve 34 is in a neutral position, which will be discussed further below. In a third articulation control valve position 34C, or cylinder retract position, the shaft 2 of the hydraulic cylinder 22 retracts, which as will be discussed in detail below, moves the frame rail 10 downward and decreases the distance between the frame rail 10 and the rear axle 25 (ride height of the tractor), also decreasing the articulation value of the hydraulic suspension system 41.

With the articulation control valve in position 34C and the mode selection valve in position 40A, the pump 37 draws fluid 42 from the reservoir 36, to line 43, to the double acting cylinder 39, which extends under pressure from fluid 42. Similar to position 34A discussed above, in the cylinder retract position 34C the extension of double acting cylinder 39 switches or maintains the mode selection valve 40 in the articulation adjustment position 40A. The fluid 42 from the double acting cylinder 39 and fluid from an articulation relief valve 33 flow back to the reservoir on line 44.

Unlike position articulation control valve 34A, when the mode selection valve 40 is in position 40A and the articulation control valve 34 is in the cylinder retract position 34C, the pump 37 draws fluid 42 from the reservoir 36, through the articulation control valve 34, to line 48, to the mode selection valve 40, to line 47, and into the low pressure cavity 11 via the low force port 11. The piston 5 retracts, thrusting fluid 42 out of the high pressure cavity 29 via the high force port 30 to the line 46. From the line 46, the fluid flows to the mode selection valve 40 (in articulation adjustment position 40A), and from the mode selection valve 40 to the articulation control valve 34 via line 45. From the articulation control valve 34 (in cylinder retract position 34C), the fluid flows to the reservoir 36.

The articulation control valve 34 sets the available limit of articulation value of the frame rails 10 (FIG. 3) relative to the rigid rear axles 25 (FIG. 2). The aerodynamic efficiency of the tractor (not shown) may increase with a reduction in available articulation value, and may decrease with an increase in available articulation value. To maximize fuel efficiency, the driver may use the minimum articulation value needed based on the road condition. It is possible that adjustment of the articulation value may be done either by manually or automatically operating the articulation control valve 34.

The maximum articulation value of the frame rail 10 is adjustable when the articulation control valve 34 is in the cylinder extend position 34A or the cylinder retract position 34C. When the articulation control valve 34 is moved from either the cylinder extend position 34A or the cylinder retract position 34C to the cylinder neutral position 34B, the actuating cylinder 39 is retracted to bring the mode selection valve 40 from the articulation adjustment position 40A to the cushion-ride pressure position 40B.

In the cylinder neutral position 34B, fluid is pumped on the pump 37 from the reservoir 36 and flows from the articulation control valve 34, to line 44, to the double acting cylinder 39, causing the cylinder to retract, and bringing the mode selection valve 40 to the cushion-ride pressure position 40B. Fluid exits the double acting cylinder 39 and returns to the articulation control valve 34 via line 43. From the articulation control valve 34, the fluid flows to the reservoir 36.

When the mode selection valve is in position 40B, there is selectively no fluid communication between the articulation control valve 34 and the hydraulic cylinder 22. In position 40B, the hydraulic cylinder 22 is selectively fluidly connected to the pressure absorber 31 to adjust the stiffness of the hydraulic suspension system 41.

When the mode selection valve 40 is in the cushion-ride pressure position 40B, the mode selection valve 40 is in fluid communication with the pressure absorber 31 to generally maintain the piston 5 in the hydraulic cylinder 22 in the position that the piston was extended or retracted to under the control of the articulation control valve 34. The pressure absorber 31 may be a nitrogen accumulator, or any other kind of pressure absorber, including hydro-pneumatic accumulators. The pressure absorber 31 acts as a reservoir of fluid that recovers energy consumed by the hydraulic cylinder 22 to absorb and dampen roadway bumps and dips.

The pressure absorber 31 provides equal line fluid pressure to both the low force port 28 and the high force port 30 so that both the low force cavity 11 and the high force cavity 29 are provided with equal pressure. The equal line fluid pressure at both the low force port 28 and the high force port 30 may result in a net displacement of the piston 5 into cavity 29. The piston 5 has a nipple 61, providing a first end 62 of the piston with relatively greater surface area compared to a second end 63 of the piston. The surface area at the first end 62 is significantly larger than the surface area at the second end 63, resulting in a suspension system 41 that can support large loads on the fifth wheel (not shown). The nipple 61 prevents the piston 5 from closing off port 30 and bottoming out in the hydraulic cylinder 22, and provides greater surface area for greater force.

The pressure level in the pressure absorber 31 is controlled by a cushion-ride control valve 35 that controls the flow of fluid 42 to and from the reservoir 36. It is possible that the cushion-ride control valve 35 may be either manually controlled or automatically controlled with pneumatic, hydraulic or electrical controls, or any other controls. The cushion-ride control valve 35 may have three positions. A first position 35A, or pressure increase position, increases the pressure in the pressure absorber 31. A second position 35B, or neutral pressure position, locks the amount of pressure at the pressure absorber 31. A third position 35C, or pressure decrease position, decreases the pressure at the pressure absorber 31.

In the pressure increase position 35A, the pressure in the hydraulic cylinder 22 is increased, providing a “stiffer” dampening of the hydraulic suspension system 41. Fluid 42 is pumped with the pump 37 to line 49 to the pressure absorber 31. The fluid flows from line 49 to line 50 to the mode selection valve 40 (in position 40B). A gauge 38 may be located on line 50 to determine the pressure at the pressure absorber 31. From the mode selection valve 40 (in position 40B), the fluid flows on both lines 46 and 47 to both the low pressure cavity 11 and the high pressure cavity 29 of the hydraulic cylinder 22. The pressure in the pressure absorber 31 also increases, applying a back-pressure on the hydraulic cylinder 22. A relief valve 32 allows fluid to flow back to the cushion-ride control valve 35 on line 51, and from the valve 35 to the reservoir 36.

In the pressure decrease position 35C, the pressure in the hydraulic cylinder 22 is decreased, providing a less stiff dampening of the hydraulic suspension system 41. Fluid 42 from the hydraulic cylinder 22 flows from both the low pressure cavity 11 and the high pressure cavity 29 on lines 46 and 47 to the mode selection valve 40 (in position 40B), from the mode selection valve 40 to line 50, and from the line 50 to line 49. From line 49, the fluid 42 flows to the cushion-ride control valve 35 (in pressure decrease position 35C) and to the reservoir 36. The back pressure at the pressure absorber 31 is lowered when line 49 is in fluid communication with the reservoir 36.

The second position 35B is a neutral position where the dampening or cushion-ride pressure inside the hydraulic cylinder 22 is locked and the piston 5 is generally locked into the extended/retracted position set by the articulation control valve 34, while at the same time allowing for full extension or retraction of the piston 5 within the hydraulic cylinder 22 when the tractor encounters bumps or dips in the road surface. The neutral position 35B allows the tractor (not shown) to follow a road surface profile and maintain a uniform frame rail 10 articulation and clearance from the road surface. In other words, if the tractor hits a bump, the distance between the top of the frame rail 10 to the road surface at the bump (and the rear axle 25) may become smaller because the frame rail 10 may not displace upwards with the bump and the axle, but instead the hydraulic cylinder 22 may compress to absorb the impact as the tractor passes over the bump, and then the piston 5 may return to the previous set extension or retraction within the hydraulic cylinder 22 and the frame 10 may return to the previous ride height (distance between frame 10 and the rear axle 25). In this way, the hydraulic cylinder 22 provides dampening during this articulation, and the piston 5 may have a generally constant extension while the cushion ride control valve 35 is in the neutral position 35B.

It should be appreciated that the pump 37 and the reservoir 36 that are hydraulically connected to the articulation control valve 34 and the cushion-ride control valve 35 may be the same pump and reservoir, however it is possible that separate pumps and reservoirs may be used. Further, it should be appreciated that other hydraulic configurations of lines and valves may be used to extend and retract the hydraulic cylinder 22.

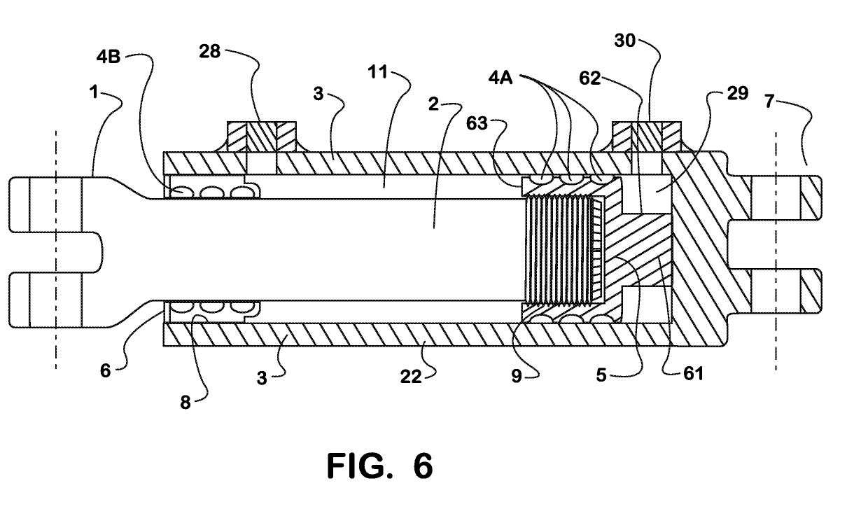

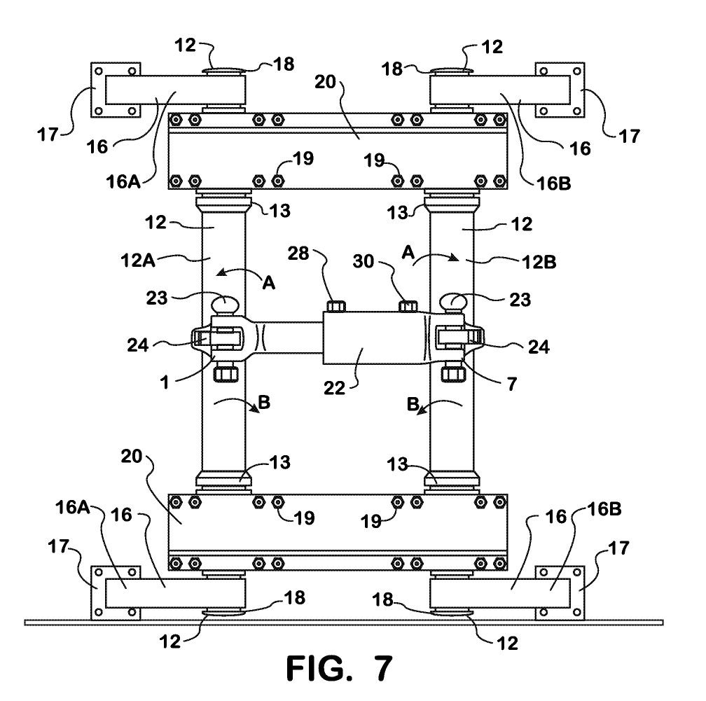

Referring now to FIG. 6, the hydraulic cylinder 22 may have a generally cylindrical casing 3. The shaft 2 may be generally elongate and may be attached to the generally cylindrical piston 5 at a rod attachment structure 9, such as threads. The piston 5 may be in sealing engagement with an interior surface of the cylindrical casing 3 with a seal 4A, such as O-rings. A shaft bushing 8 may enclose the low force cavity 11 and sealingly engage the shaft 2 with a seal 4B, such as O-rings. A shaft wiper 6 may be concentrically disposed around the shaft 2.

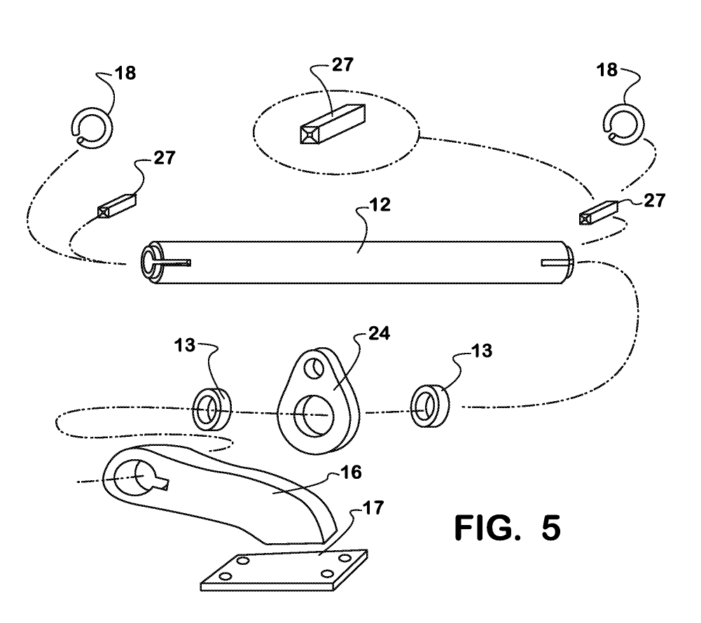

Referring now to FIG. 2 through FIG. 7, the apparatus of the hydraulic suspension system 41 will be discussed. The hydraulic cylinder 22 may have the moving clevis 1 at one of the shaft 2, and at the other end of the shaft 2, a fixed clevis 7. Both ends 1, 7 are connected to two generally parallel rock shafts 12A, 12B with mount pivots 24 (FIG. 2 and FIG. 5). The moving clevis 1 and the fixed clevis 7 are each attached to the mount pivots 24 with a clevis pin assembly 23 (FIG. 2). The mount pivots 24 link the hydraulic cylinder 22 to the rock shafts 12A, 12B.

As seen in FIG. 5, the rock shaft 12 is inserted into a first hole 52 in the mount pivot 24, and may have lateral stops 13 located on each side of the mount pivot to prevent the relative rotation of the rock shaft 12 within the first hole 52 of the mount pivot 24. Rotation of the mount pivot 24 rotates the rock shaft 12, which is linked to a trailing arm 16 with a rock shaft key 27. The rock shaft key 27 is received in a receiving formation 53 of the rock shaft 12, and a lock spring clip 18 maintains the rock shaft key 27 in the receiving formation 53. The rock shaft key 27 also rotationally fixes the trailing arm 16 to the rock shaft 12 with a second receiving formation 54. A second hole 55 in the mount pivot 24 receives the clevis pin assembly 23 for linking the moving clevis 1 and the fixed clevis 7 to the mount pivots 24.

As seen in FIGS. 3 and 4, the rock shaft 12 may be attached to the frame rail 10 with a cradle 20 that is mounted on the frame rail with a frame rail fastener 21. A bearing 15 may attach the rock shaft 12 to the cradle 20 with fasteners 19. The bearing 15 may permit the rotation of the rock shaft 12 within a bearing hole 56. Grease fittings 14 may be disposed on the bearing 15 to introduce grease into the bearing hole 56.

Extending from the trailing arm 16 may be an axle mounting plate 17. The axle mounting plate 17 may receive a U-bolt 26 to attach the rigid rear axle 25 to the mounting plate.

Referring to FIG. 2, the trailing arm 16 has an “x” and a “y” dimensional component, where “x” is generally horizontal and generally parallel with the road surface and “y” is generally vertical and generally perpendicular to the road surface. When the shaft 2 extends out of the hydraulic cylinder 22, the hydraulic cylinder causes the rock shafts 12 to rotate in an outwardly opposing direction, seen by arrows A. When the trailing arms 16 rotate with the rock shaft 12 in the direction of arrows A, the height of the frame 10 above the rear axle 25 (and road surface) increases as the “y” component of the trailing arm 16 increases, and the frame rails 10 carried by the bearing 15 displace up along the y-axis away from the rear axles 25.

With the mode selection valve 40 in the position 40B, the hydraulic cylinder 22 generates a constant rotational, downward force on the rock shaft 12 and trailing arms 16 seen by arrows A. When the shaft 2 retracts into the hydraulic cylinder 22, the hydraulic cylinder causes the rock shafts 12 to rotate in an inwardly opposing direction, seen by arrows B. When the trailing arm 16 rotates with the rock shaft 12 in the direction of arrows B, the “y” component of the trailing arm 16 decreases, and the frame rails 10 carried by the bearing 15 displace down along the y-axis towards the rear axles 25. It is also possible that extension of the hydraulic cylinder 22 may move the frame rail 10 down with respect to the rear axle 25, and retraction of the hydraulic cylinder 22 may move the frame rail 10 up.

The hydraulic suspension system 41 mechanically performs like a walking beam suspension. Specifically, and referring to FIG. 2, when the hydraulic suspension system 41 is set to a maximum articulation of 20-inches, the hydraulic suspension system 41 will work as follows. If a 20-inch high road bump is encountered by the tractor, a first rear axle 25A will go up about 10-inches (or a distance “y” for other bump heights and set articulation values), fixedly rotating a first trailing arm 16A and a first axle rock shaft 12A, pushing or imparting pressure on the hydraulic cylinder 22, which will fixedly rotate a second axle rock shaft 12B and a second trailing arm 16B, lowering a second rear axle 25B about 10-inches (or the same distance “y” for other bump heights and set articulation values), resulting in a total of 20-inches of articulation. Once the bump reaches the second rear axle 25B, the second rear axle goes up 10-inches and the front rear axle 25A goes down 10-inches, again resulting in a total of 20-inches of articulation. Depending on the maximum articulation set, for example at 16-inches, the first rear axle 25A may displace half of the articulation y, for example 8-inches, and the second rear axle 25B may displace in the opposite direction the same value y, for example 8-inches. When the first rear axle 25A is displaced upwards a distance y, the first trailing arm 16A and the first rock shaft 12A fixedly rotate, imparting a force on the hydraulic cylinder 22, which fixedly rotates the second rock shaft 12B and the second trailing arm 16B, displacing the second rear axle 25B downwards a distance y.

The rotation of the trailing arms 16 increases the ride height of the tractor and the maximum articulation value. The hydraulic suspension system 41 is adjustable to accommodate the different vocations, including common highway long haul tractors, which may need as little as 4-inches of articulation, and off-road vocations such as logging and mining, which may require 20-inches of articulation. The hydraulic suspension system 41 may be adjustable to have maximum articulation values ranging between 6-inches to 20-inches.

As seen in FIG. 2 and FIG. 7, it should be appreciated that the suspension system apparatus may have two rock shafts 12A, 12B, that are generally parallel to each other, and two frame rails 10 that are attached to each rock shaft 12A, 12B. There may be four trailing arms 16A, 16B that have fixed rotation with the rock shafts 12A, 12B, and four rear axles 25A, 25B. The hydraulic cylinder 22 may be connected to the two rock shafts 12A, 12B. Extension and retraction of the hydraulic cylinder 22 rotates the rock shafts 12A, 12B and the trailing arms 16A, 16B, which displaces the frame rail 10 with respect to the rear axles 25A, 25B to set the ride height of the tractor and the maximum articulation value.

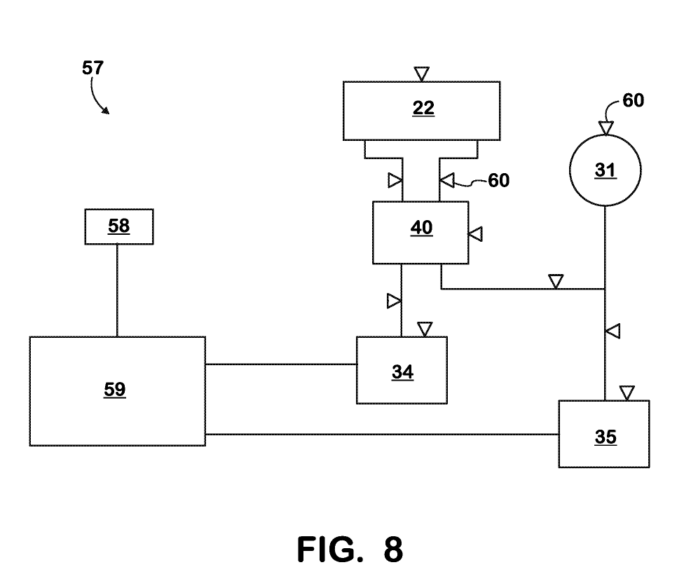

Referring now to FIG. 8, both the articulation control valve 34 and the cushion-ride control valve 35 may be controlled either manually or automatically. The tractor (not shown) may have a control system 57 having control interface 58 operable by the user that inputs commands to a micro-processor 59 to adjust the articulation value at the articulation control valve 34 or to adjust the stiffness at the cushion-ride control valve 35. Sensors 60 may be located along the lines 43-51 (FIG. 1), at the pressure absorber 31, at the mode-selection valve 40, and at the hydraulic cylinder 22, as well as other locations, to monitor the conditions in the hydraulic suspension system 41.

It is possible that the sensors 60 and the micro-processor 59 continuously monitor conditions in the hydraulic suspension system 41. From the recent conditions in the hydraulic suspension system 41, the micro-processor 59 may predict future conditions in the system 41. Further, the micro-processor 59 may automatically adjust the articulation value based on predicted conditions in the hydraulic suspension system 41. The conditions in the hydraulic suspension system 41 may be a direct result of road conditions, thus the micro-processor 59 may automatically predict the road conditions based on previous road conditions. The control system 57 may automatically adjust the ride height and maximum articulation valve based on the predicted road conditions.

At lower ride heights, the tractor is more aerodynamically efficient, so the micro-processor 59 may determine the lowest ride height for a particular road condition. The control system 57 may automatically adjust the maximum articulation value based on both the road conditions and the aerodynamic loading on the tractor. Further, the micro-processor 59 may automatically decrease the ride height of the tractor when the user ingresses and egresses from the tractor, for example when the ignition is switched off or the door is opened, among other conditions.

The hydraulic cylinder 22 raises and lowers the frame rails 10 by controlling the rotation of the trailing arms 16. Specifically, the hydraulic cylinder 22 controlling the “y” component of the trailing arm 16 determines the displacement of the frame rails 10. It is possible that the articulation value of the frame rails 10 may be from a minimum of about 6-inches to a maximum of about 20-inches from the rear axle 25, although other ranges of values are possible. Since the axles 25 may displace half of the maximum articulation value, the axles 25A, 25B may be able to displace up or down about 3-10 inches. While the cushion ride valve 35 is in position 35B, the hydraulic cylinder 22 dampens the impact of a road bump/dip while generally maintaining the piston 5 within the extended or retracted position of the cylinder 22 to generally maintain the ride height of the tractor.

The hydraulic suspension system 41 eliminates the low-efficiency engine driven compressor used in conventional air spring systems, and provides adjustable rear suspension articulation value and adjustable stiffness of the hydraulic suspension system. It is possible that the hydraulic suspension system 41 can provide about 20-inches of maximum articulation. Additionally, the hydraulic suspension system 41 maintains the rigid rear axle 25 parallel to the driving surface.

What is claimed is:

1. A hydraulic suspension system for a vehicle, comprising:
a hydraulic cylinder having an extendable and retractable piston that is operable to raise and lower a frame rail with respect to a rear axle;
a mode selection valve in fluid communication with the hydraulic cylinder, wherein the mode selection valve has an articulation adjustment position and a cushion-ride pressure position;
a pressure absorber in fluid communication with the mode selection valve and in selective fluid communication with the hydraulic cylinder;
an articulation control valve in fluid communication with the mode selection valve and in selective fluid communication with the hydraulic cylinder, the articulation control valve having a cylinder extend position, a cylinder retract position, and a neutral position, wherein a maximum articulation value of the frame rail is adjustable when the articulation control valve is in at least one of the cylinder extend position and the cylinder retract position;
wherein when the articulation control valve is in at least one of the cylinder extend position and the cylinder retract position, the mode selection valve is switched to the articulation adjustment position and the articulation control valve provides fluid communication from a reservoir to the hydraulic cylinder; and
wherein when the articulation control valve is in the neutral position, the mode selection valve is switched to a cushion-ride pressure position and the pressure absorber is in fluid communication with the hydraulic cylinder.

2. The hydraulic suspension system of claim 1 further comprising a cushion-ride control valve in fluid communication with the mode selection valve and in selective fluid communication with the hydraulic cylinder.

3. The hydraulic suspension system of claim 2 wherein the cushion-ride control valve has a pressure increase position, a neutral pressure position, and a pressure decrease position, wherein in the pressure increase position the pressure at the pressure absorber is increased.

4. The hydraulic suspension system of claim 1 wherein the mode selection valve is actuated by a double acting hydraulic cylinder to switch between the articulation adjustment position and the cushion-ride pressure position.

5. The hydraulic suspension system of claim 4 wherein when the articulation control valve is in the cylinder extend position, a pump draws fluid from the reservoir to the articulation control valve, and from the articulation control valve to the double acting cylinder to switch the mode selection valve to the articulation adjustment position.

6. The hydraulic suspension system of claim 5 further comprising an articulation relief valve in fluid communication with the double acting cylinder, wherein fluid from the double acting cylinder and fluid from the articulation relief valve flows back to the articulation control valve and to the reservoir.

7. The hydraulic suspension system of claim 4 wherein when the articulation control valve is in the neutral position, a pump draws fluid from the reservoir to the articulation control valve, and from the articulation control valve to the double acting cylinder to switch the mode selection valve to the cushion-ride pressure position.

8. The hydraulic suspension system of claim 2 wherein the cushion-ride control valve is automatically operated with a micro-processor.

9. The hydraulic suspension system of claim 1 wherein the articulation control valve is operated with a micro-processor to automatically adjust the articulation value based on existing road conditions.

10. A method of adjusting an articulation value of a frame rail of a vehicle with respect to a rear axle in a hydraulic suspension system, the method comprising the steps of:
providing a hydraulic cylinder having an extendable and retractable piston that is operable to raise and lower the frame rail with respect to the rear axle;
fluidly connecting a mode selection valve with the hydraulic cylinder, wherein the mode selection valve has an articulation adjustment position and a cushion-ride pressure position;
fluidly connecting a pressure absorber with the mode selection valve;
fluidly connecting an articulation control valve with the mode selection valve;
selectively fluidly connecting the articulation control valve with the hydraulic cylinder when the mode selection valve is in the articulation adjustment position; and
pumping fluid from a reservoir to the articulation control valve, from the articulation control valve to the mode selection valve, and from the mode selection valve to the hydraulic cylinder to at least one of extending and retracting the hydraulic cylinder.

11. The method of claim 10 further comprising the steps of:
fluidly connecting a double acting hydraulic cylinder with the articulation control valve, wherein the double acting hydraulic cylinder is extendable and retractable; and
switching the mode selection valve between the articulation adjustment position and the cushion-ride pressure position with extension and retraction of the double acting hydraulic cylinder.

12. A hydraulic suspension system for a tractor, comprising:
a first rock shaft generally parallel to a second rock shaft;
a frame rail attached to the first rock shaft and the second rock shaft;
a first trailing arm attached to the first rock shaft and having fixed rotation with the first rock shaft,
a second trailing arm attached to the second rock shaft and having fixed rotation with the second rock shaft;
a first rear axle attached to the first trailing arm;
a second rear axle attached to the second trailing arm; and
a hydraulic cylinder connected to the first rock shaft and to the second rock shaft.

13. The hydraulic suspension system of claim 12 wherein when the first rear axle is displaced upwards a distance y, the first trailing arm and the first rock shaft fixedly rotate, imparting a force on the hydraulic cylinder, which fixedly rotates the second rock shaft and the second trailing arm, displacing the second rear axle downwards a distance y.

14. The hydraulic suspension system of claim 13 wherein the distance y is between 3 and 10 inches.

15. The hydraulic suspension system of claim 12 further comprising a mount pivot which links the hydraulic cylinder to the first rock shaft.

16. The hydraulic suspension system of claim 12 wherein rotation of the first trailing arm is fixed to the first rock shaft with a rock shaft key received in a receiving formation of the first rock shaft and in a second receiving formation of the first trailing arm.

17. The hydraulic suspension system of claim 12 wherein a bearing attaches the first rock shaft to the frame rail and allows the rotation of the first rock shaft within a bearing hole, and wherein the bearing is attached to a cradle that is attached to the frame rail with a fastener.

18. The hydraulic suspension system of claim 12 further comprising a pressure absorber in selective fluid communication with the hydraulic cylinder.

19. The hydraulic suspension system of claim 12 further comprising a mode selection valve in fluid communication with the hydraulic cylinder.

20. The hydraulic suspension system of claim 19 further comprising an articulation control valve in fluid communication with the mode selection valve.
